(19) United States
(12) Patent Application Publication
(10) Pub. No.: US 2014/0162017 A1
(43) Pub. Date: Jun. 12, 2014

(54) MOLDED POLYMERIC ARTICLE

(71) Applicant: NYX, Inc., Livonia, MI (US)

(72) Inventor: Chain S. Sandhu, Livonia, MI (US)

(21) Appl. No.: 14/101,695

(22) Filed: Dec. 10, 2013

Related U.S. Application Data
(60) Provisional application No. 61/735,341, filed on Dec. 10, 2012.

(51) Int. Cl. B29D 99/00

(52) U.S. Cl. CPC B29D 99/0003
USPC 428/81; 428/156; 264/299

(57) ABSTRACT

A molded polymeric article includes a polymeric wall that has first and second legs that join each other at an inside corner. The first and second legs include respective continuous surfaces that meet at the inside corner and transition at respective inflections into a corner notch. The corner notch includes side surfaces extending from the inflections to a bottom surface that joins the side surfaces. The corner notch facilitates the mitigation of thermal warpage of the polymeric wall.

### CROSS-REFERENCE TO RELATED APPLICATION

This application claims priority to U.S. Provisional Ser. No. 61/735,341, which was filed Dec. 10, 2012.

### BACKGROUND

This disclosure relates to polymeric articles. Polymeric articles can be formed by injection molding, for example. A molded polymeric article can warp such that the surfaces of the article distort from the intended design shape. The warpage results from material shrinkage during cooling, differential cooling between locations of the article, and molded-in residual stresses.

### SUMMARY

A molded polymeric article according to an example of this disclosure includes a polymeric wall that has first and second legs that join each other at an inside corner. The first and second legs include respective continuous surfaces that meet at the inside corner and transition at respective inflections into a corner notch. The corner notch includes side surfaces extending from the inflections to a bottom surface that joins the side surfaces. The corner notch facilitates the mitigation of thermal warpage of the polymeric wall.

Also disclosed is a method of fabricating the molded polymeric article.

In another aspect, a molded polymeric article according to an example of this disclosure includes a polymeric wall that has first and second legs that join each other at an inside corner. The inside corner includes a corner notch that is located along the inside corner with respect to a maximum radius of curvature of the inside corner.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example molded polymeric article.

FIG. 2 shows an isolated view of a corner notch of a molded polymeric article.

FIG. 3 shows an isolated view of another example corner notch of a molded polymeric article.

FIG. 4 illustrates another example molded polymeric article.

### DETAILED DESCRIPTION

FIG. 1 schematically illustrates a representative portion of a molded polymeric article 20. As an example, the molded polymeric article 20 can be a vehicle component, such as a console component, but is not limited to such components. As will be described, the article 20 includes features for mitigating warpage that can occur upon cooling of the article 20 after molding.

In the illustrated example, the article 20 includes a polymeric wall 22 that has a first leg 24 and a second leg 26 that join each other at an inside corner, represented at 28, and an outside corner, represented at 30. The first and second legs 24/26 include respective continuous surfaces 24a/26a that meet at the inside corner 28. The continuous surfaces 24a/26a transition at respective inflections 24b/26b into a corner notch 32.

The corner notch 32 is also shown in an isolated view in FIG. 2. The corner notch 32 includes side surfaces 34 that extend from the respective inflections 24b/26b to a bottom surface 36 (relative to the open side) that joins the side surfaces 34. As illustrated, the corner notch 32 in this example is non-rectilinear such that the side surfaces 34 and the bottom surface 36 are all non-linear, curved surfaces.

The polymeric wall 22 defines a thickness, or a nominal thickness, represented at “t,” and the corner notch 32 defines a notch depth, represented at “d.” In one example, the notch depth is 25% to 50% of the thickness of the polymeric wall 22. In a further example, the thickness of the polymeric wall 22 is 2-4 millimeters.

The corner notch 32 facilitates the mitigation of warpage of the polymeric article 20. For example, warpage can occur from material shrinkage during cooling, differential cooling between locations of the article, and molded-in residual stresses. The differential cooling can occur because of a difference in surface area available for heat rejection during cooling immediately after molding. For instance, a corner that does not include a corner notch as disclosed herein would have a greater surface area on the outside corner than on the inside of the corner.

The corner notch 32 herein serves to effectively decrease mass and increase the surface area of the inside corner 28 so that the surface area of the inside corner, represented by the area of the side surfaces 34 and the bottom surface 36, is a closer match to the surface area of the outside corner, represented by the curved surface portion at SA, of the outside corner 30. For example, the size of the notch 32 can be selected such that the surface area of the inside corner is approximately equal to the surface area of the outside corner. Thus, the surfaces area can be equal or approximately equal to reduce differential cooling. The notch depth of 25% to 50% of the thickness of the polymeric wall 22 serves to provide the desired surface area and reduction in mass, to reduce differential cooling.

Additionally, the location of the corner notch 32 along the inside corner 28 can be selected with respect to a maximum radius of curvature, represented in FIG. 1 at point C. For example, the corner notch 32 is located at the maximum radius of curvature of the inside corner. Such a location provides additional surface area in a corner location where there would be a maximum differential cooling relative to the outside corner 30. Thus, the features of the relative notch depth, the surface area of the inside corner relative to the outside corner, and the location of the corner notch 32 along the inside corner 28 individually and combinationally mitigate warpage of the polymeric wall 22.

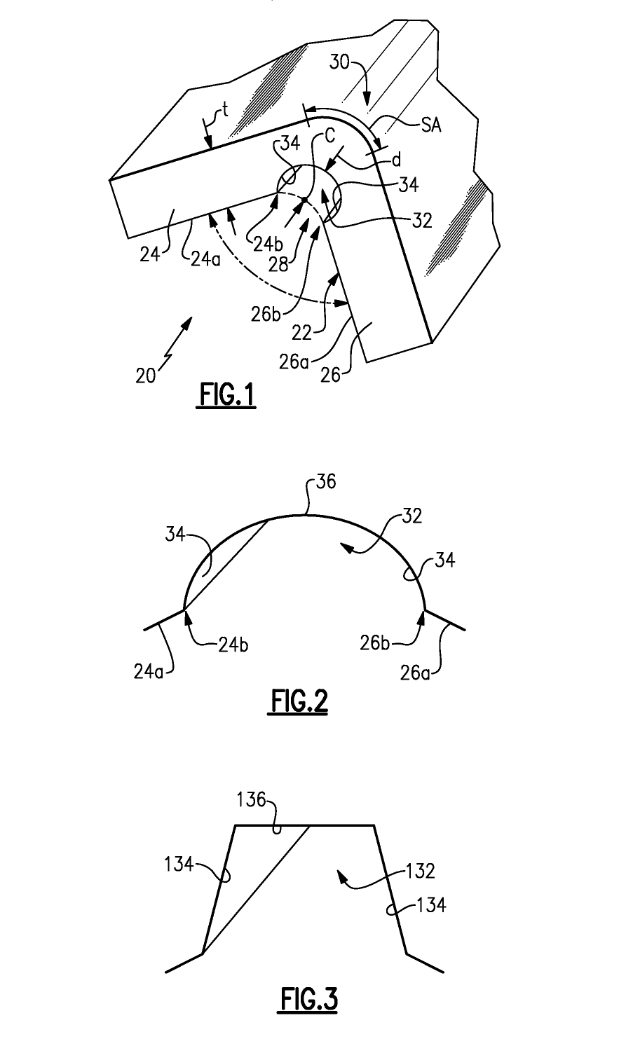

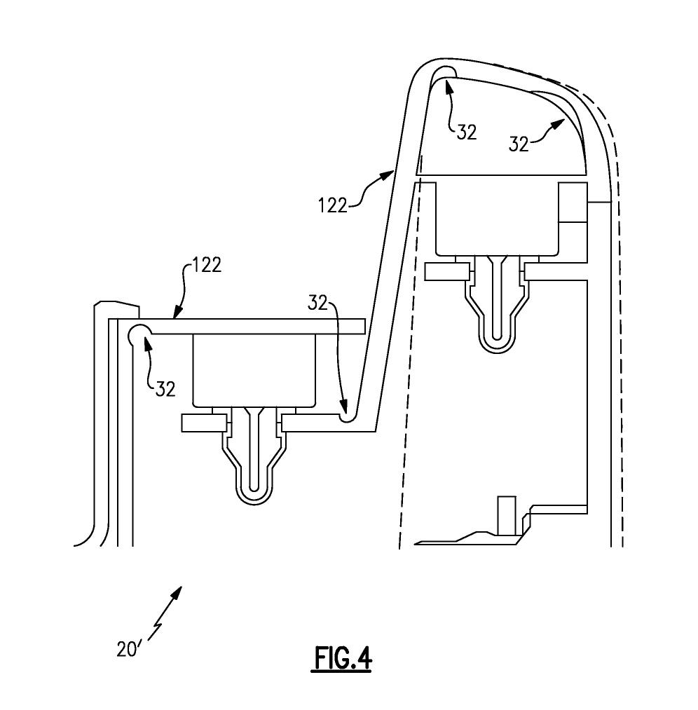

FIG. 3 illustrates another example corner notch 132. In this example, the corner notch 132 is rectilinear and includes linear side surfaces 134 and a linear bottom surface 136 that joins the side surfaces 134. As can be appreciated, other rectilinear shapes can alternatively be used, although the non-rectilinear shape may avoid the introduction of stress concentration points at the corners.

FIG. 4 illustrates a portion of a molded polymeric article 20′. In this example, the article 20′ is a portion of a vehicle console assembly. The vehicle console assembly includes polymeric walls 122 that include one or more corner notches 32. As described above, the corner notches 32 facilitate the mitigation of warpage and thus can provide greater dimensional accuracy in the molding and fabrication of such polymeric articles.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A molded polymeric article comprising:
a polymeric wall including first and second legs that join each other at an inside corner, the first and second legs including respective continuous surfaces that meet at the inside corner and transition at respective inflections into a corner notch, the corner notch including side surfaces extending from the respective inflections to a bottom surface that joins the side surfaces.

2. The article as recited in claim 1, wherein the corner notch has a notch depth, and the notch depth is 25% to 50% of the thickness of the polymeric wall.

3. The article as recited in claim 1, wherein the corner notch has a notch depth, and the notch depth is approximately 50% of the thickness of the polymeric wall.

4. The article as recited in claim 1, wherein the corner notch is non-rectilinear.

5. The article as recited in claim 1, wherein the corner notch is rectilinear.

6. The article as recited in claim 1, wherein the corner notch is located along the inside corner with respect to a maximum radius of curvature of the inside corner.

7. The article as recited in claim 1, wherein the corner notch is located along the inside corner at a maximum radius of curvature of the inside corner.

8. The article as recited in claim 1, wherein the continuous surfaces define an angle there between of 120° or less.

9. The article as recited in claim 1, wherein the polymeric wall has a nominal thickness of 2-4 millimeters, and the corner notch has a notch depth, and the notch depth is approximately 50% of the nominal thickness of the polymeric wall.

10. The article as recited in claim 1, wherein the first and second legs also join at an outside corner opposite the inside corner, the outside corner being smooth and notch-free.

11. The article as recited in claim 1, wherein the first and second legs also join at an outside corner opposite the inside corner, wherein the corner notch provides a surface area in the inside corner that is approximately equal to a surface area of the outside corner.

12. A method of fabricating a molded polymeric article, the method comprising:
molding a polymeric wall having first and second legs that join each other at an inside corner, the first and second legs being molded to include respective continuous surfaces that meet at the inside corner and transition at respective inflections into a corner notch, the corner notch including side surfaces extending from the inflections to a bottom surface that joins the side surfaces.

13. A molded polymeric article comprising:
a polymeric wall including first and second legs that join each other at an inside corner, the inside corner including a corner notch that is located along the inside corner with respect to a maximum radius of curvature of the inside corner.

14. The article as recited in claim 13, wherein the corner notch is located along the inside corner at the maximum radius of curvature of the inside corner.

15. The article as recited in claim 14, wherein the polymeric wall has a nominal thickness of 2-4 millimeters, and the corner notch has a notch depth, the notch depth being approximately 25% to 50% of the nominal thickness of the polymeric wall, and the first and second legs also join at an outside corner opposite the inside corner, wherein the corner notch provides a surface area in the inside corner that is approximately equal to a surface area of the outside corner, the notch depth, location of the corner notch along the inside corner and the surface area mitigating thermal warpage of the polymeric wall.
